(19) United States
(12) Patent Application Publication
(10) Pub. No.: US 2019/0295338 A1
(43) Pub. Date: Sep. 26, 2019

(54) METHOD FOR MONITORING A COMPONENT, AND A DRIVE TRAIN

(71) Applicant: KOKI TECHNIK Transmission Systems GmbH, Niederwurschnitz (DE)

(72) Inventors: Bernd Schulze, Niederdorf (DE); Ingolf Grüssner, Chemnitz (DE)

(21) Appl. No.: 16/360,104

(22) Filed: Mar. 21, 2019

(30) Foreign Application Priority Data
Mar. 21, 2018 (DE) 10 2018 106 627.9

(51) Int. Cl. G07C 5/08; G01M 17/007

(52) U.S. Cl. CPC G07C 5/0808; G01M 17/007; G07C 5/085

(57) ABSTRACT

A method for component monitoring in a vehicle powertrain includes the following steps:
an oscillation profile of a component in working position or rest position is detected;
a vibration sensor (1) detects the vibration profile of the component as a data information;
the data information of the vibration sensor (1) is detected wirelessly by a receiver (2);
the receiver (2) transmits the data information to a computer (3) and/or a memory device (6);
the computer (3) and/or the memory device (6) carries out an actual/target comparison of the data information;
the result of the actual/target comparison is evaluated and/or further processed.

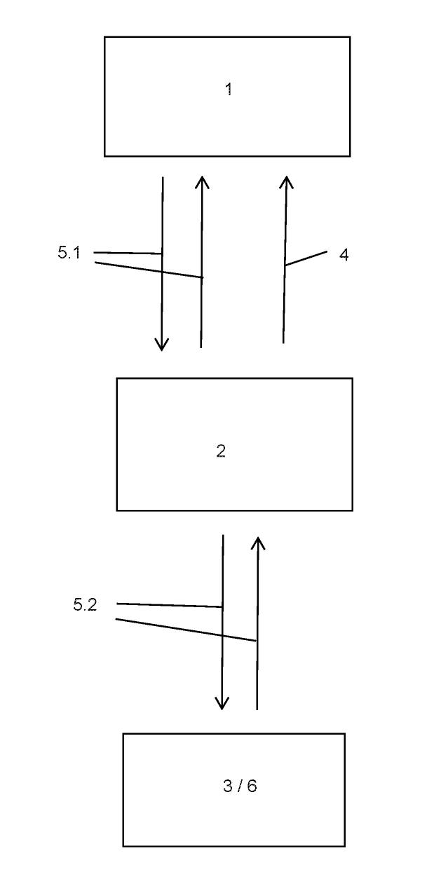

### TECHNICAL FIELD

The invention relates to a method for component monitoring in a vehicle drive train, and to a drive train.

### STATE OF THE ART

DE 10 2007 044 425 A1 discloses a device for detecting the position of a shift fork of a gearbox. A damping element is mounted there as a position transmitter, which dampens a high-frequency field generated by a stationary sensor and designed as an oscillating circuit. The sensor can deduce the position of the damping element in the high-frequency field from the degree of damping and thus detects the position of the shifting arm.

A disadvantage of the state of the art is that there is an increase in weight due to the components used, whereby hardly any reliable information on the predictive component behaviour in the moving vehicle is generated for example for preventive replacement of components, which can be used, for example, to prevent failures.

### OBJECT OF THE INVENTION

The object of this invention is to overcome the disadvantages arising from the state of the art. In particular, a method and a drive train shall be provided which guarantee permanent and/or interval monitoring of all or individual components of a drive train.

### Solution of the Object

The characteristics disclosed herein lead to the solution of the object.

Advantageous designs are also described herein and in dependent claims.

The method according to the invention for component monitoring in a vehicle powertrain comprises the following steps:

an oscillation profile of a component in working position or rest position is recorded;

a vibration sensor records the vibration profile of the component as a data information;

the data information of the vibration sensor is acquired wirelessly by a receiver;

the receiver transmits the data information to a computer and/or a memory device;

the computer and/or the memory device carries out an actual/target comparison of the data information;

the result of the actual/target comparison is evaluated and/or further processed.

The vehicle drive train consists of a large number of component groups, such as engine, clutch, transmission, drive shafts and axle differentials. These component groups in turn consist of a large number of individual components. This situation is independent of the drive source used, such as combustion engine and/or electric motor. Passenger cars, trucks, motorcycles or the like can be considered as vehicles.

Each component and also each individual part used in the components have a characteristic vibration behaviour. If changes occur in the component, the vibration behaviour of the individual part, the component or the component group also changes.

For example, the vibration sensor can also detect a change in shape. The vibration sensor can record the sound emissions in such a way that later the difference between a rule-compliant vibration in the case of an intact component, an irregular vibration in the case of a bend or change in the design or the presence of a crack or hairline crack in the component can be detected. The corresponding frequencies of the present rule-compliant or irregular cases are detected and determined on the basis of the actual/target comparison.

The design of the component groups up to the components is carried out via simulation calculations, which can define the behaviour of the components under different loads. Among other things, modal analysis is used to analyse the natural frequency in order to avoid resonances, for example. Resonances can cause the individual component to oscillate up to the drive train (system). On the basis of experimental studies the determined frequency values of the components, component groups and systems are verified and could be documented finally in the component documents as target values.

From today's point of view, a continuous monitoring of the component behaviour means a special challenge, but at the same time the chance to exert a specific influence on the design of the components.

The integration of a vibration sensor or a receiver on or in the component of the vehicle powertrain, in the particularly invention-relevant case of shift forks, represents a high requirement.

The vibration sensor records the vibration profile of, for example, a component or an individual part in the component. The vibration profile is transmitted wirelessly to the receiver as data information. The data information supplied by the vibration sensor is used for online analysis of the component. The data information is used to evaluate parameter changes of the component, such as position, shape, frequency and temperature.

In accordance with the invention, it is possible to permanently receive signals describing the condition of selected components or component groups. This in turn has the advantage that it makes it possible to monitor these components in a targeted manner over their lifetime.

The vibration profile characteristic of the selected components, such as frequency, amplitude or phase shift, can change depending on the operating state and serves as a reference, i.e. as a setpoint. If deviations from these setpoints occur during the use of the component, the comparison of actual/setpoint value provides the possibility of evaluating both the condition of the individual component and the other components linked to the component, for example in the component element or the entire vehicle drive train.

In the best case, the sensor technology required for measurement and monitoring is integrated in the component in question in the form of the vibration sensor, without being directly exposed to the surrounding conditions, such as oil, salt water, dirt, shock, etc. . . . . At the same time, the sensors should not decisively influence the component properties.

The vibration sensor is included to record the vibration profile in the component. The idea is that the vibration sensor is integrated into the matrix of the component. This ensures that the wireless signal transmission to the receiver is guaranteed. In this context, included means embedding or attaching the vibration sensor. For this purpose, the vibration sensor can be embedded in a plastic matrix, for example. For this purpose, the plastic matrix itself can be the component or, as a plastic element, part of the component. However, the vibration sensor can also be placed on a metallic body, but its protection against external influences must also be ensured.

The data information of the vibration sensor is used to monitor the component, a component group or a system. The data information is used to evaluate parameter changes of the component, such as position, shape, frequency, and/or temperature.

The signal transmission from the vibration sensor to the receiver is wireless. The signal transmission can take place permanently or at intervals. Interval can also mean that the transmission of the data information is carried out at a certain repetition rate, for example.

The vibration sensor is assigned to the first component and the receiver is assigned to another component. The first component is rotating and the second component is stationary. This can only be done, for example, if the receiver is in the transmission range of the vibration sensor. Thus, the vibration sensor can be mounted on a mobile rotating shaft and interact with stationary receivers permanently installed in a housing. The data information of the vibration profile of the revolving vibration sensor will be provided by the receiver, depending on the design, either at intervals when the range of the receiver is exceeded or permanently.

It is also possible to retrieve the sensor signal as required. This can be done, for example, during a regular component check. For this purpose, the receiver is brought into a designated housing position and receives the data information of the vibration sensor.

The vibration sensor is wirelessly connected to a receiver. In a design example, the vibration sensor is designed in such a way that an electromagnetic field is generated or a piezo element is present. The vibration sensor can, for example, be an electromagnetic field sensor.

The transmitted data information is transmitted on the basis of inductive coupling in the frequency ranges LF, HF or on the basis of electromagnetic waves in the frequency range UHF.

The receiver is operatively connected to a computer and/or a memory device. This is done regularly via cables.

### BRIEF DESCRIPTION OF THE DRAWINGS

Further advantages, characteristics and details of the invention result from the following description of preferred embodiments as well as from the drawings; these show in the single FIGURE a scheme of the method according to the invention.

### DETAILED DESCRIPTION

The FIGURE shows a scheme of the method according to the invention.

There a vibration sensor 1 is given. The vibration sensor 1 is supplied wirelessly with energy 4 by a receiver 2.

Between the vibration sensor 1 and the receiver 2 a wireless data transmission 5.1 from the vibration sensor 1 to the receiver 2 and from the receiver 2 to the vibration sensor 1 is displayed.

Furthermore it is shown how a data transmission 5.2 between a computer 3 and/or a memory device 6 to the receiver 2 and away from the receiver 2 to the computer 3 and/or a memory device 6 takes place.

The vibration sensor 1 records the vibration profile characteristic of a drive train component, such as frequency, amplitude and/or phase shift, depending on the operating position, i.e. operating condition or rest position. The vibration profile is transmitted as wireless data information 5.1 to the receiver 2. In addition, the receiver 2 transmits energy 4 to the vibration sensor 1.

In this example, wireless data transmission 5.1 between vibration sensor 1 and receiver 2 takes place on the basis of inductive coupling in the frequency ranges LF, HF and on the basis of electromagnetic waves in the frequency range UHF.

The data information read by receiver 2 is forwarded to computer and/or memory device 6 for storage and evaluation.

This is the technique known as Radio Frequency Identification (RFID). Data on 5.2 is preferably via cable, but can also be wireless.

Reference List

| | |
|---|---|
| 1 | vibration sensor |
| 2 | receivers |
| 3 | computer |
| 4 | energy transfer |
| 5.1 | wireless data transmission |
| 5.2 | data transmission |
| 6 | storage device |

1. A method for component monitoring in a vehicle drive train, comprising the following steps:
a vibration profile of a component in working position or rest position is detected;
a vibration sensor (1) detects the vibration profile of the component as a data information;
the da information of the vibration sensor (1) is detected wirelessly by a receiver (2);
the receiver (2) transmits the data information to a computer (3) and/or a memory device (6);
the computer (3) and/or the memory device (6) carries out an actual/target comparison of the data information;
the result of the actual/target comparison is evaluated and/or further processed.

2. The method according to claim 1, wherein the vibration sensor (1) generates an electromagnetic field or is a piezo element.

3. The method according to claim 1, wherein the data information of the vibration sensor (1) is used for monitoring the component, a component group or a system.

4. The method according to claim 1, wherein the transmitted data information is sent based on inductive coupling in the frequency ranges LF, HF or on the basis of electromagnetic wave in the frequency range UHF.

5. The method according to claim 1, wherein the data information is used for evaluating parameter changes of the component.

6. The method according to claim 5, wherein the parameter changes are position, shape, frequency and/or temperature.

7. The method according to claim 1, wherein the data information of the vibration sensor (1) is sent to the receiver (2) at intervals or permanently.

8. A motor vehicle drive train having a first component, wherein an oscillation sensor (1) for detecting an oscillation profile is included.

9. The motor vehicle drive train according to claim 8, wherein the vibration sensor (1) is in wireless operative connection with a receiver (2).

10. The motor vehicle drive train according to claim 9, wherein the receiver (2) is operatively connected to a computer (3) and/or a memory device (6).

11. The motor vehicle drive train according to claim 8, wherein the vibration sensor (1) is an electromagnetic field sensor or a piezo element.

12. The motor vehicle drive train according to claim 8, wherein the vibration sensor (1) is assigned to the first component and the receiver (2) is assigned to a further component.

13. The motor vehicle train drive train according to claim 12, wherein the first component is arranged so as to rotate and the second component is arranged so as to be stationary.
